(19) United States
(12) Patent Application Publication
(10) Pub. No.: US 2014/0146513 A1
(43) Pub. Date: May 29, 2014

(54) DISPLAY APPARATUS

(71) Applicant: SAMSUNG DISPLAY CO., LTD., Yongin-City (KR)

(72) Inventors: Seong-Sik CHOI, Seoul (KR); Atsushi NEMOTO, Hwaseong-si (KR); Su-Chang RYU, Cheonan-si (KR)

(73) Assignee: Samsung Display Co., Ltd., Yongin-City (KR)

(21) Appl. No.: 13/858,254

(22) Filed: Apr. 8, 2013

(30) Foreign Application Priority Data
Nov. 27, 2012 (KR) 10-2012-0135115

(51) Int. Cl. F21V 33/00; F21V 8/00; B29C 53/04; F21V 9/14

(52) U.S. Cl. CPC F21V 33/0052; F21V 9/14; G02B 6/0011; B29C 53/04
USPC 362/19; 362/97.1; 362/611; 362/606; 156/196

(57) ABSTRACT

A display apparatus includes a display panel, a light source part disposed under the display panel configured to supply light to the display panel, and a receiving container. The receiving container is configured to receive the display panel and the light source part. The receiving container includes a bottom portion and a first side wall extending from a first side of the bottom portion along a direction substantially perpendicular to the bottom portion. A first protrusion is formed inside of the first side wall. The first protrusion is disposed between a lower surface of the display panel adjacent to the first side of the display panel and an upper surface of the light source part. The receiving container includes metal.

### CROSS-REFERENCE TO RELATED APPLICATION

This application claims priority to Korean Patent Application No. 10-2012-0135115, filed on Nov. 27, 2012, the disclosure of which is hereby incorporated by reference herein in its entirety.

### 1. TECHNICAL FIELD

Exemplary embodiments of the invention relate to a display apparatus.

More particularly, exemplary embodiments of the present invention relate to a liquid crystal display apparatus.

### 2. DISCUSSION OF THE RELATED ART

Recently, a display apparatus having light weight and small size has been manufactured. A cathode ray tube (CRT) display apparatus has been used due to a performance and a competitive price. However the CRT display apparatus may have deficiencies with regard to size and/or portability. Therefore the liquid display apparatus has been highly regarded due to the small size, light weight and low-power-consumption of the liquid display apparatus.

A liquid crystal display apparatus may be configured to apply a voltage to a specific molecular arrangement of liquid crystal molecules to change the molecular arrangement of the liquid crystal molecules. The liquid crystal display apparatus displays an image using changes of optical property (for example, birefringence, rotatory polarization, dichroism and light scattering) of a liquid crystal cell according to the changes of the molecular arrangement.

The liquid crystal display apparatus includes a liquid crystal display panel, and a backlight assembly providing light to the liquid crystal display panel. In addition, for example, a mold frame may be necessary to fix the liquid crystal display panel and the backlight assembly in a chassis. However, additional cost may be required to provide the mold frame.

### SUMMARY

Exemplary embodiments of the invention provide a display apparatus without a mold frame.

According to an exemplary embodiment of the invention, a display apparatus includes a display panel, a light source part disposed under the display panel and configured to supply light to the display panel, and a receiving container. The receiving container is configured to receive the display panel and the light source part. The receiving container includes a bottom portion and a first side wall extending from a first side of the bottom portion along a direction substantially perpendicular to the bottom portion. A first protrusion is formed inside of the first side wall. The first protrusion is disposed between a lower surface of the display panel adjacent to the first side of the display panel and an upper surface of the light source part. The receiving container includes metal.

In an exemplary embodiment, the first protrusion may be substantially parallel with the bottom portion. The first protrusion may make contact with the lower surface of the display panel adjacent to the first side of the display panel and is configured to support the display panel thereon.

In an exemplary embodiment, the first protrusion may extend from an upper portion of the first side wall.

In an exemplary embodiment, a hook may be formed on the first protrusion. The hook may make contact with the first side of the display panel.

In an exemplary embodiment, a first panel supporting part may be disposed on an inside upper portion of the first side wall. The first panel supporting part may include elastic insulation material.

In an exemplary embodiment, the first panel supporting part may have a U-shaped cross section. The first panel supporting part may surround the inside upper portion, an outside upper portion and an upper surface of the first side wall.

In an exemplary embodiment, the first panel supporting part may be a shrink tube.

In an exemplary embodiment, the display apparatus may further include a second panel supporting part including elastic insulation material and disposed on the first protrusion of the first side wall. The second panel supporting part may make contact with the lower surface of the display panel adjacent to the first side of the display panel.

In an exemplary embodiment, the first panel supporting part may include a second side wall extending from a second side of the bottom portion along a direction substantially perpendicular to the bottom portion. The second side may be opposite to the first side. The second side wall may face the first side wall. A second protrusion may be formed inside of the second side wall.

In an exemplary embodiment, the display apparatus may further include a third panel supporting part disposed on an inside upper portion of the second side wall. The third panel supporting part may include elastic insulation material. A fourth panel supporting part may be disposed on the second protrusion of the second side wall. The fourth panel supporting part may include elastic insulation material.

In an exemplary embodiment, the display apparatus may further include a covering part surrounding a peripheral portion of the display panel and an outside of the first side wall of the receiving container.

In an exemplary embodiment, the display apparatus may further include a polarizer disposed on the display panel, and exposing the peripheral portion of the display panel. Thickness of the polarizer may be same as thickness of the covering part.

In an exemplary embodiment, the covering part may be a tape comprising an adhesive layer. The adhesive layer may be attached to the peripheral portion of the display panel and the outside of the first side wall of the receiving container.

In an exemplary embodiment, the covering part may be a top chassis combined with the receiving container configured to receive the display panel and the light source part.

In an exemplary embodiment, the first panel supporting part may extend to the first protrusion. The first panel supporting part may cover the inside upper portion of the first side wall and an upper surface of the first protrusion.

In an exemplary embodiment, the light source part may include a light guiding plate, and a light source disposed on a first side surface of the light guiding plate. The light source may be received in a space formed by the first wide wall, the first protrusion and the bottom portion of the receiving container

In an exemplary embodiment, the light source part further may include an optical element disposed on the light guiding plate.

In an exemplary embodiment, the optical element may include a diffusion sheet, a prism sheet, and a protecting sheet. The protecting sheet is disposed at a top of the optical element. An upper surface of the protecting sheet adjacent to a first side of the protecting sheet may make contact with a lower surface of the first protrusion of the first side wall of the receiving container.

In an exemplary embodiment, the light source may be spaced apart from the first side wall of the receiving container.

In an exemplary embodiment, the receiving container may include metal having elastic restoring three. The light source may make contact with the first side wall of the receiving container.

In an exemplary embodiment, the receiving container may include metal having relatively high reflectivity. The light guiding plate may make contact with the bottom portion of the receiving container.

In an exemplary embodiment, the light source part may further include an optical element disposed on the light guiding plate.

In an exemplary embodiment, a thickness of the first protrusion may be about twice of thickness of the first side wall.

According to an exemplary embodiment of the invention, a display apparatus includes a display panel, a light source part disposed under the display panel configured to supply light to the display panel, and a receiving container configured to receive the display panel and the light source part. The receiving container includes a bottom portion and a first side wall extending from a first side of the bottom portion along a direction substantially perpendicular to the bottom portion. A first protrusion is formed inside of the first side wall. The first protrusion is disposed between a lower surface of the display panel adjacent to the first side of the display panel and an upper surface of the light source part. The thickness of first side wall is substantially same as the thickness of the first protrusion.

In an exemplary embodiment, the thickness of the bottom portion may be same as the thickness of first side wall.

According to exemplary embodiment of the invention, a method for manufacturing a receiving container for a display apparatus is provided. The method includes forming a bottom portion and a first side wall of a receiving container, wherein the first side wall extends from a first side of the bottom portion along a direction substantially perpendicular to the bottom portion, forming a first protrusion disposed inside of the first side wall, in which the first protrusion is configured to be disposed between a lower surface of a display panel of the display apparatus adjacent to a first side of the display panel and an upper surface of a light source part of a backlight unit disposed under the display panel, and wherein the receiving container comprises a metal.

In addition, the method further includes bending ends of the bottom portion which are not connected to the first sidewall to form the receiving container.

According to the exemplary embodiments of the present invention, a first protrusion is fanned on a first side of a display apparatus, so that a display panel and a backlight assembly may be received without a mold frame.

In addition, a first panel supporting part including elastic insulation material is disposed between the first side wall and a first side of the display panel. A second panel supporting part including elastic insulation material is disposed on the first protrusion. Thus, the display panel may be fixed in the receiving container, and be protected from outside impact.

In addition, an upper portion of the first side wall of the receiving container is surrounded by the first panel supporting part. Thus, when the display apparatus is manufactured, a worker may be protected from being wounded by sharp edges of the first side wall of the receiving container.

In addition, the receiving container may include metal and has elastic restoring force, and the first protrusion has relatively small size compared to the whole receiving container, so that the backlight assembly may be inserted into the space below the first protrusion by the elastic restoring force of the receiving container.

In addition, the receiving container includes metal having relatively high reflectivity, so that the receiving container may reflect light from a light source toward the first side wall and the first protrusion without an additional reflecting plate. In addition, heat generated from the light source may be effectively dissipated. In addition, the receiving container may reflect light, which is from a lower surface of the light guiding plate, to a light guiding plate without an additional reflecting element under the light guiding plate.

In addition, the receiving container includes a receiving space for the light source, and the receiving container may guide light adjacent to the light source to the light guiding plate.

### BRIEF DESCRIPTION OF THE DRAWINGS

Exemplary embodiments of the invention can be understood in more detail from the following detailed description taken in conjunction with the accompanying drawings, in which:

FIG. 1 is an exploded perspective view illustrating a display apparatus according to an exemplary embodiment of the invention;

FIG. 2 is a cross-sectional view taken along a line I-I′ of FIG. 1;

FIG. 3 is an exploded perspective view illustrating a display apparatus according to an exemplary embodiment of the invention;

FIG. 4 is a cross-sectional view taken along a line II-II′ of FIG. 3;

FIG. 5 is a cross-sectional view illustrating a display apparatus according to an exemplary embodiment of the invention;

FIG. 6 is a cross-sectional view illustrating a display apparatus according to an exemplary embodiment of the invention;

FIG. 7 is a cross-sectional view illustrating a display apparatus according to an exemplary embodiment of the invention;

FIG. 8 is a cross-sectional view illustrating a display apparatus according to an exemplary embodiment of the invention;

FIG. 9 is an exploded perspective view illustrating a display apparatus according to an exemplary embodiment of the invention;

FIG. 10 is a cross-sectional view taken along a line III-III′ of FIG. 9;

FIG. 11 is a cross-sectional view illustrating a display apparatus according to an exemplary embodiment of the invention;

FIG. 12 is a cross-sectional view illustrating a display apparatus according to an exemplary embodiment of the invention;

FIG. 13 is a cross-sectional view illustrating a display apparatus according to an exemplary embodiment of the invention;

FIGS. 14A and 14B are perspective views to explain a method for manufacturing a receiving container of the display apparatus of FIG. 1;

FIG. 15 is a perspective views to explain a method for manufacturing a receiving container of the display apparatus of FIG. 8; and

FIGS. 16A and 16B are perspective views to explain a method for manufacturing a receiving container of the display apparatus of FIG. 12.

### DETAILED DESCRIPTION OF EXEMPLARY EMBODIMENTS

It will be understood that when an element or layer is referred to as being “on” or “connected to” another element or layer, the element or layer can be directly on or connected to another element or layer or intervening elements or layers may also be present. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the invention will be explained in detail with reference to the accompanying drawings.

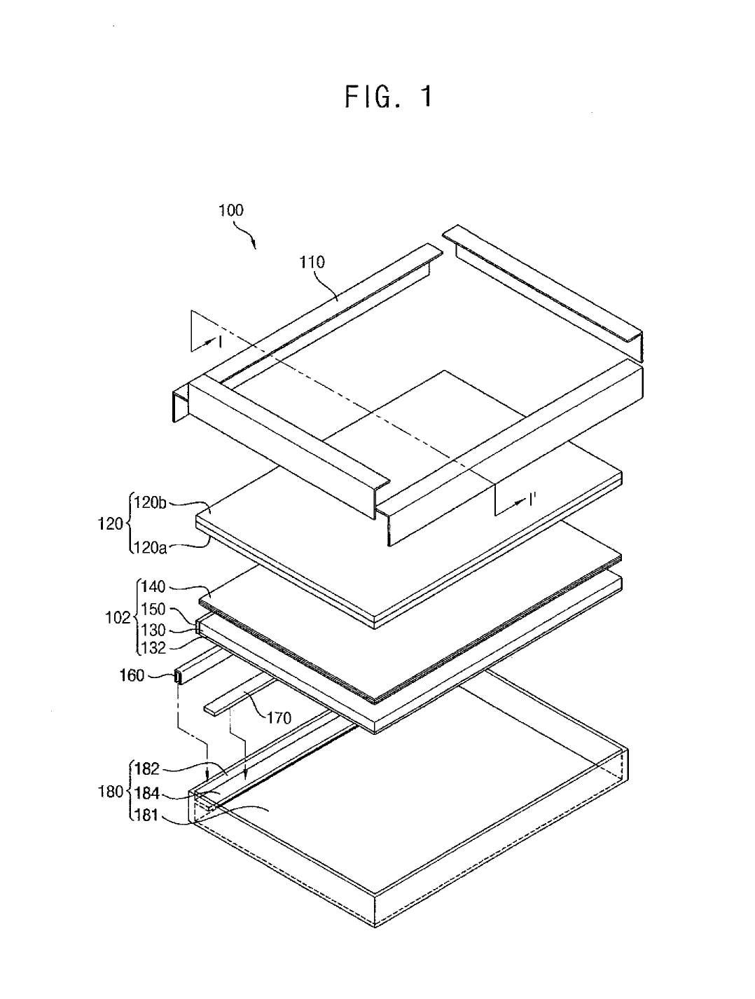

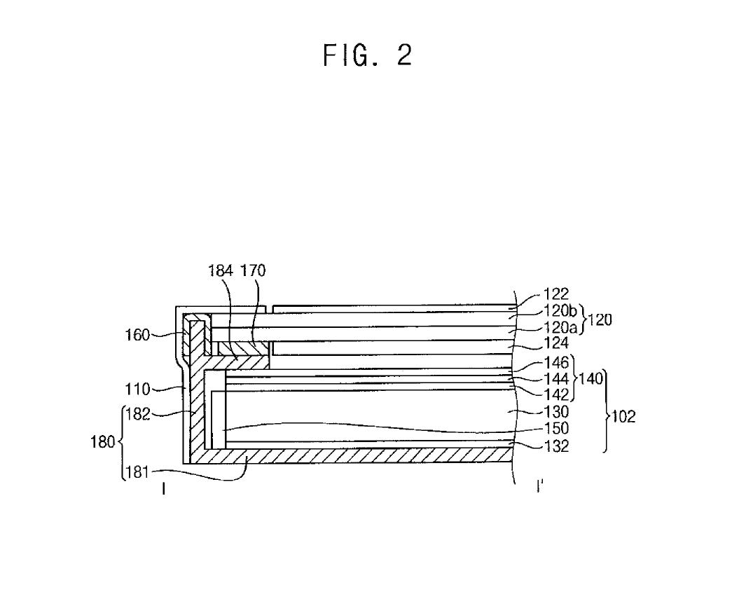

FIG. 1 is an exploded perspective view illustrating a display apparatus according to an exemplary embodiment of the invention. FIG. 2 is a cross-sectional view taken along a line I-I′ of FIG. 1.

Referring to FIGS. 1 and 2, the display apparatus 100 includes, for example, a covering part 110, a display panel 120, a backlight assembly 102, a first panel supporting part 160, a second panel supporting part 170 and a receiving container 180.

The display panel 120 displays an image using light from the backlight assembly 102 according to driving signal and data signal applied from outside. The display panel 120 includes, for example, an array substrate 120a, an opposite substrate 120b facing the array substrate 120a, and a liquid crystal layer disposed between the array substrate 120a and the opposite substrate 120b.

The array substrate 120a may include, for example, a plurality of gate lines, a plurality of data lines crossing the gate lines, and a plurality of switching element connected to the gate and data lines. The opposite substrate 120b may include, for example, a black matrix blocking light and a color filter having a color. Although the opposite substrate 120b includes the color filter in the present exemplary embodiment, the color filter may be formed in the array substrate 120a. The liquid crystal layer is disposed between the array substrate 120a and the opposite substrate 120b. The liquid crystal layer includes liquid crystal molecules having, for example, optically anisotropic. The liquid crystal molecules are driven by electric field, so that light may pass through or be blocked by the liquid crystal layer to display an image.

An upper polarizer 122 is disposed on the display panel 120. A lower polarizer 124 is disposed under the display panel 120. Each of the upper polarizer 122 and the lower polarizer 124 changes light passing therethrough to polarized light. An axis of polarization of the upper polarizer 122 may be, for example, substantially perpendicular to an axis of polarization of the lower polarizer 124. The lower polarizer 124 may be, for example, a reflective-type polarizer. Although the upper polarizer 122 is disposed on the display panel 120 and the lower polarizer 124 is disposed under the display panel 120 in the present exemplary embodiment, the upper polarizer 122 and the lower polarizer 124 may alternatively be disposed instead in the display panel 120 thereby forming an in-cell polarizer.

The display panel 120 may be electrically connected to a driving part (not shown) to drive the display panel 120. For example, the driving part may be a flexible printed circuit board. The driving part may be electrically connected to the array substrate. The driving part may be disposed, for example, under or at a side of the backlight assembly 102.

The backlight assembly 102 includes, for example, a light guiding plate 130, an optical element 140, and a light source 150. The backlight assembly 102 generates light to provide the light to the display panel 120.

The light guiding plate 130 guides the light from the light source 150 to the display panel 120. The light guiding plate 130 converts an incident light having a light distribution of the spot light source or the line light source to an exiting light having a light distribution of a surface light source. Thus, the light guiding plate 130 guides the light from the light source 150 toward the display panel 120. Although the light guiding plate 130 is described having uniform thickness in the present exemplary embodiment, the light guiding plate 130 may have various shapes. For example, the light guiding plate 130 may have a wedge shaped cross section. The thickness of the light guiding plate 130 may be getting smaller as far from the light source 150 to form the wedge shaped cross section. The light guiding plate 130 may be formed of, for example, an acryl resin, such as polymethyl methacrylate (“PMMA”) or polycarbonate.

The optical element 140 is disposed on the light guiding plate 130. The optical element 140 may increase the optical property of the light from the light guiding plate 130. Thus, the optical element 140 may make the brightness of the light from the light guiding plate 130 be uniform. The optical element 140 may include, for example, a plurality of optical sheets. For example, optical element 140 may include a protecting sheet 146, a prism sheet 144 and a diffusion sheet 142. The diffusion sheet 142 is disposed on a light exiting surface of the light guiding plate 130. The prism sheet 144 is disposed on the diffusion sheet 142. The protecting sheet 146 is disposed on the prism sheet 144. The prism sheet 144 may include, for example, an upper prism sheet and a lower prism sheet. An axis of the upper prism sheet may be, for example, substantially perpendicular to an axis of the lower prism sheet. Although the optical element 140 is described including the protecting sheet 146, the prism sheet 144 and the diffusion sheet 142, many modifications of the optical sheet may be possible. For example, in an exemplary embodiment, the optical element 140 may include one diffusion sheet 142, one prism sheet 144 and one protective sheet 146. Moreover, in an exemplary embodiment, for example, at least one of the diffusion sheet 142, the prism sheet 144, and the protective sheet 146 may be provided in plurality to form the optical element 140 according to the characteristics of the display device. In addition, for example, in an exemplary embodiment, one of the diffusion sheet 142, the prism sheet 144, and the protective sheet 146 may be omitted.

The light source 150 generates light to provide the light to the light guiding plate 130. The light source 150 is disposed adjacent to a first side surface of the light guiding plate 130. The light source 150 may include, for example, a plurality of LED (light emitting diode) light sources, and may be a spot light source or a line light source generating the light. Alternatively, in an exemplary embodiment, the light source 150 may be a line light source including a cold cathode fluorescent lamp, a hot cathode fluorescent lamp, or an external electrode florescent lamp.

The backlight assembly 102 may further include, for example, a reflecting plate 132. The reflecting plate 132 may reflect the light, which is toward a lower surface opposite to the light exiting surface, to the display panel 120, so that luminance efficiency may be increased. The reflective plate 132 may be formed of, for example, a reflective material, such as polyethylene terephthalate (PET) or aluminum. Alternatively, the reflective plate 132 may include other materials such as, for example, polybutylene terephthalate (PBT) or a resin such as polycarbonate (PC) blended in polyethylene terephthalate (PET) or polybutylene terephthalate (PBT).

The receiving container 180 receives the backlight assembly 102 and the display panel 120. The receiving container 180 may consist of, for example, metal. For example, the receiving container 180 may consist of at least one of the following materials of aluminum, aluminum alloys, stainless steel, or steel electro galvanized cold-rolled coil (SECC). The receiving container 180 includes, for example, a bottom portion 181 and a first side wall 182. The first side wall 182 extends from a first side of the bottom portion 181 along a direction, for example, substantially perpendicular to the bottom portion 181.

An upper portion of the first side wall 182 is surrounded by a first panel supporting part 160. The first panel supporting part 160 may have, for example, a U-shape cross-section. The first panel supporting part 160 extends along the first side wall 182. Thus, the first panel supporting part 160 surrounds the upper portion, a portion of an inside surface and a portion of outside surface of the first side wall 182. The first panel supporting part 160 makes contact with a side of the display panel 120.

In addition, the first panel supporting part 160 may include, for example, elastic insulation material. For example, the first panel supporting part 160 may include rubber, silicon and the like. The first panel supporting part 160 includes elastic insulation material, so that the first panel supporting part 160 may fix the display panel 120 and protect the display panel 120 from outside impact.

In addition, the first panel supporting part 160 may be, for example, a shrink tube having a U-shape or C shape cross section. The shrink tube may be combined with the first side wall 182, and thereafter the shrink tube may be thermally transformed to be close to the first side wall 182.

In addition, an upper portion of the first side wall 182 of the receiving container 180 is surrounded by the first panel supporting part 160. Thus, when the display apparatus 100 is manufactured, a worker may be protected from being wounded by sharp edges of the first side wall 182 of the receiving container 180.

A first protrusion 184 is fanned inside of the first side wall 182. A second panel supporting part 170 is disposed on an upper surface of the first protrusion 184, which is in parallel with the bottom portion 181. The second panel supporting part 170 is disposed under the first side of the display panel 120 to support the display panel 120. Thus, the second panel supporting part 170 makes contact with the display panel 120 and the first protrusion 184.

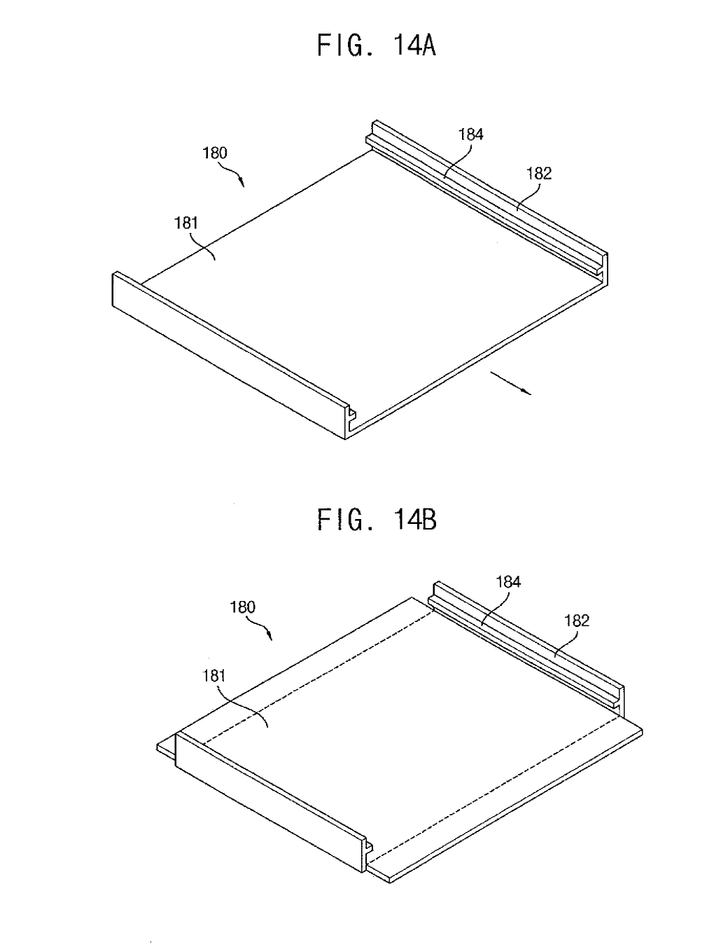

The first protrusion 184 may be formed by, for example, welding the first protrusion 184 on the first side wall 182. For example, the bottom portion 181 and the first side wall 182 are formed by a general press process. Thereafter the first protrusion 184 may be attached on the inside of the first side wall 182 by welding. In addition, the first protrusion 184 may be formed by, for example, an extruding or a bending process. Detailed explanation will be mentioned in FIGS. 14A and B.

In addition, the second panel supporting part 170 may include, for example, an elastic insulation material. For example, the second panel supporting part 170 may include rubber, silicon and the like. The second panel supporting part 170 includes, for example, elastic insulation material, so that the second panel supporting part 170 may fix the display panel 120 and protect the display panel 120 from the outside.

A lower surface opposite to the upper surface of the first protrusion 184 is disposed on the first side of the backlight assembly 102, and makes contact with the backlight assembly 102. Thus, the lower surface of the first protrusion 184 makes contact with an upper surface of the protecting sheet 146. In addition, a lower surface of the backlight assembly 102 makes contact with the bottom portion 181 of the receiving container 180. Thus, the backlight assembly 102 may be fixed in the receiving container 180.

The light source 150 is, for example, spaced apart form the first side wall 182 of the receiving container 180 by a predetermined distance. Thus, when the backlight assembly 102 is assembled into the receiving container 180, the backlight assembly 102 may be inserted into a space below the first protrusion 184.

In addition, although the light source 150 is spaced apart form the first side wall 182 in the present example embodiment, the light source 150 may, for example, alternatively contact with the first side wall 182. In this case, the receiving container 180 includes, for example, metal and has elastic restoring force, and the first protrusion 184 has relatively small size comparing to the whole receiving container 180, so that the backlight assembly 102 may be inserted into the space below the first protrusion 184 by the elastic restoring force of the receiving container 180.

The covering part 110 covers, for example, a peripheral portion of the display panel 120 and outside of the first side wall 182 of the receiving container 180 configured to fix the display panel 120 in the receiving container 180. The covering part 110 covers, for example, the peripheral portion of the display panel 120, a portion of the first panel supporting part 160, and a portion of outside of the first side wall 182. The covering part 110 may be, for example, an adhesive tape, so that the covering part 110 may fix the display panel 120 in the receiving container 180 by being attached to the peripheral portion of the display panel 120, the portion of the first panel supporting part 160, and the portion of outside of the first side wall 182.

In addition, although the display apparatus 100 includes the reflecting plate 132 in the present exemplary embodiment, the receiving container 180 includes, for example, a metal having relatively high reflectivity, so that the receiving container 180 may reflect light from the light source 150 toward the first side wall 182 and the first protrusion 184 without an additional reflecting plate. In addition, heat generated from the light source 150 may be effectively dissipated. In addition, the receiving container 180 may reflect light, which is from a lower surface of the light guiding plate 130, to the light guiding plate 130 without an additional reflecting element under the light guiding plate 130.

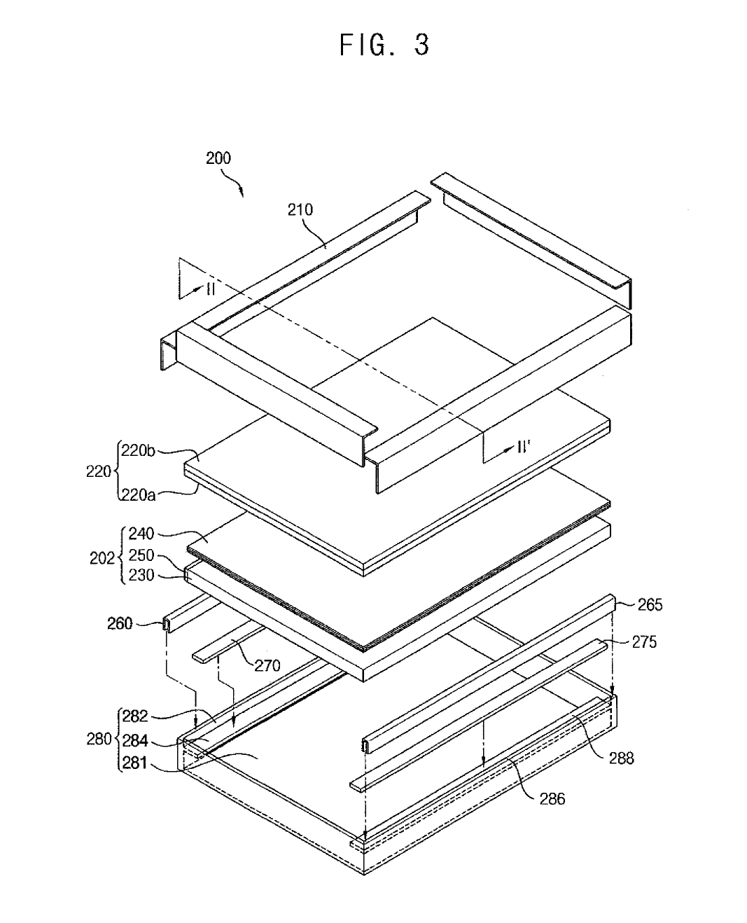

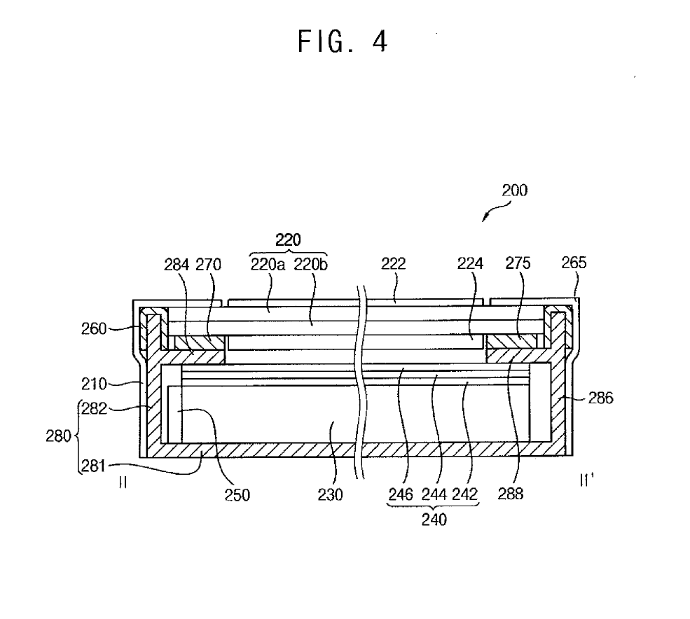

FIG. 3 is an exploded perspective view illustrating a display apparatus according to an exemplary embodiment of the invention. FIG. 4 is a cross-sectional view taken along a line II-II′ of FIG. 3.

Referring to FIGS. 3 and 4, the display apparatus 200 is substantially same as the display apparatus of FIGS. 1 and 2, except for a third panel supporting part 265 and a fourth panel supporting part 275. Thus, any further detailed descriptions concerning the same elements will be omitted.

The receiving container 280 receives the backlight assembly 202 which includes optical element 240, light source 250, and light guiding plate 230 and the display panel 220 which includes array substrate 220a and opposite substrate 220b. The optical element 240 is disposed on the light guiding plate 230 and may include, for example, a protecting sheet 246, a prism sheet 244 and a diffusion sheet 242 similar to the optical element 140 of the display apparatus 100 of FIGS. 1 and 2.

The receiving container 280 may include, for example, a metal. For example, the receiving container 280 may consist of at least one of the following materials of aluminum, aluminum alloys, stainless steel, or steel electro galvanized cold-rolled coil (SECC). The receiving container 280 includes, for example, a bottom portion 281, a first side wall 282 and a second side wall 286 facing the first side wall 282. The first side wall 282 extends, for example, from a first side of the bottom portion 281 along a direction substantially perpendicular to the bottom portion 281. The second side wall 286 extends, for example, from a second side of the bottom portion 281 along a direction substantially perpendicular to the bottom portion 281. The second side of the bottom portion 281 is, for example, opposite to the first side of the bottom portion 281.

An upper portion of the second side wall 286 is surrounded by the third panel supporting part 265. The third panel supporting part 265 may have, for example, a U-shape cross-section. The third panel supporting part 265 extends, for example, along the second side wall 286. Thus, the third panel supporting part 265 surrounds the upper portion, a portion of an inside surface and a portion of outside surface second side wall 286. The third panel supporting part 265 makes contact with, for example, a side of the display panel 220.

In addition, the third panel supporting part 265 may include, for example, elastic insulation material. For example, the third panel supporting part 265 may include rubber, silicon and the like. The third panel supporting part 265 includes, for example, elastic insulation material, so that the third panel supporting part 265 may fix the display panel 220 and protect the display panel 220 from outside impact.

In addition, the third panel supporting part 265 may be, for example, a shrink tube having a U-shape or C shape cross section. The shrink tube may be combined with the second side wall 286, and thereafter the shrink tube may be thermally transformed to be close to the second side wall 286.

In addition, an upper portion of the second side wall 286 of the receiving container 280 is surrounded by the third panel supporting part 265. Thus, when the display apparatus 200 is manufactured, a worker may be protected from being wounded by sharp edges of the second side wall 286 of the receiving container 280.

A first protrusion 284 is formed inside of the first side wall 282. A second panel supporting part 270 is disposed on an upper surface of the first protrusion 284, which is in parallel with the bottom portion 281. The second panel supporting part 270 is disposed under the first side of the display panel 220 to support the display panel 220. Thus, the second panel supporting part 270 makes contact with the display panel 220 and the first protrusion 284.

In addition, the second panel supporting part 270 may include, for example, elastic insulation material. For example, the second panel supporting part 270 may include rubber, silicon and the like. The second panel supporting part 270 includes elastic insulation material, so that the second panel supporting part 270 may fix the display panel 220 and protect the display panel 220 from the outside.

A lower surface opposite to the upper surface of the first protrusion 284 is disposed on the first side of the backlight assembly 202, and makes contact with the backlight assembly 202. Thus, the lower surface of the first protrusion 284 makes contact with an upper surface of the protecting sheet 246. In addition, a lower surface of the backlight assembly 202 makes contact with the bottom portion 281 of the receiving container 280. Thus, the backlight assembly 202 may be fixed in the receiving container 280.

A light source 250 is, for example, spaced apart form the first side wall 282 of the receiving container 280 by a predetermined distance. Thus, when the backlight assembly 202 is assembled into the receiving container 280, the backlight assembly 202 may be inserted into a space below the first protrusion 284. Although in the present exemplary embodiment, the light source 250 is disposed only adjacent to a first side of the light guiding plate 230, exemplary embodiments of the present invention are not limited thereto. For example, in an exemplary embodiment, another light source may be disposed adjacent to a second side opposite to the first side of the light guiding plate 230.

In addition, although the light source 250 is spaced apart form the first side wall 282 in the present example embodiment, the light source 250 may alternatively, in an exemplary embodiment contact to the first side wall 282. In this case, the receiving container 280 consists of, for example, a metal and has elastic restoring force, and the first protrusion 284 has relatively small size compared to the whole receiving container 280, so that the backlight assembly 202 may be inserted into the space below the first protrusion 284 by the elastic restoring force of the receiving container 280.

A second protrusion 288 is formed inside of the second side wall 286. A fourth panel supporting part 275 is disposed on an upper surface of the second protrusion 288 which is in parallel with the bottom portion 281. The fourth panel supporting part 275 is disposed under the first side of the display panel 220 to support the display panel 220. Thus, the fourth panel supporting part 275 makes contact with the display panel 220 and the second protrusion 288.

In addition, the fourth panel supporting part 275 may include, for example, elastic insulation material. For example, the fourth panel supporting part 275 may include rubber, silicon and the like. The fourth panel supporting part 275 includes, for example, elastic insulation material, so that the fourth panel supporting part 275 may fix the display panel 220 in the receiving container 280 and protect the display panel 220 from an outside impact.

A lower surface opposite to the upper surface of the second protrusion 288 is disposed on a second side of the backlight assembly 202 opposite to the first side of the backlight assembly 202, and makes contact with the backlight assembly 202. Thus, the lower surface of the second protrusion 288 makes contact with an upper surface of the protecting sheet 246. In addition, a lower surface of the backlight assembly 202 makes contact with the bottom portion 281 of the receiving container 280. Thus, the backlight assembly 202 may be fixed in the receiving container 280.

The second side of the backlight assembly 202 is, for example, spaced apart from the second side wall 286 of the receiving container 280 by a predetermined distance. Thus, when the backlight assembly 202 is assembled into the receiving container 280, the backlight assembly 202 may be inserted into a space below the second protrusion 288.

In addition, although the second side of the backlight assembly 202 is spaced apart form the second side wall 286 of the receiving container 280 in the present exemplary embodiment, the second side of the backlight assembly 202 may alternatively instead contact with the second side wall 286 in an exemplary embodiment. In this case, the receiving container 280 consists of, for example, metal and has elastic restoring force, and the second protrusion 288 has relatively small size compared to the whole receiving container 280, so that the backlight assembly 202 may be inserted into the space below the second protrusion 288 by the elastic restoring force of the receiving container 280.

Further, the display apparatus of FIGS. 3 and 4 also includes an upper polarizer 222 disposed on the display panel 220 and a lower polarizer 224 disposed under the display panel 220 similar to the upper polarizer 122 and lower polarizer 124 of the display apparatus 100 of FIGS. 1 and 2.

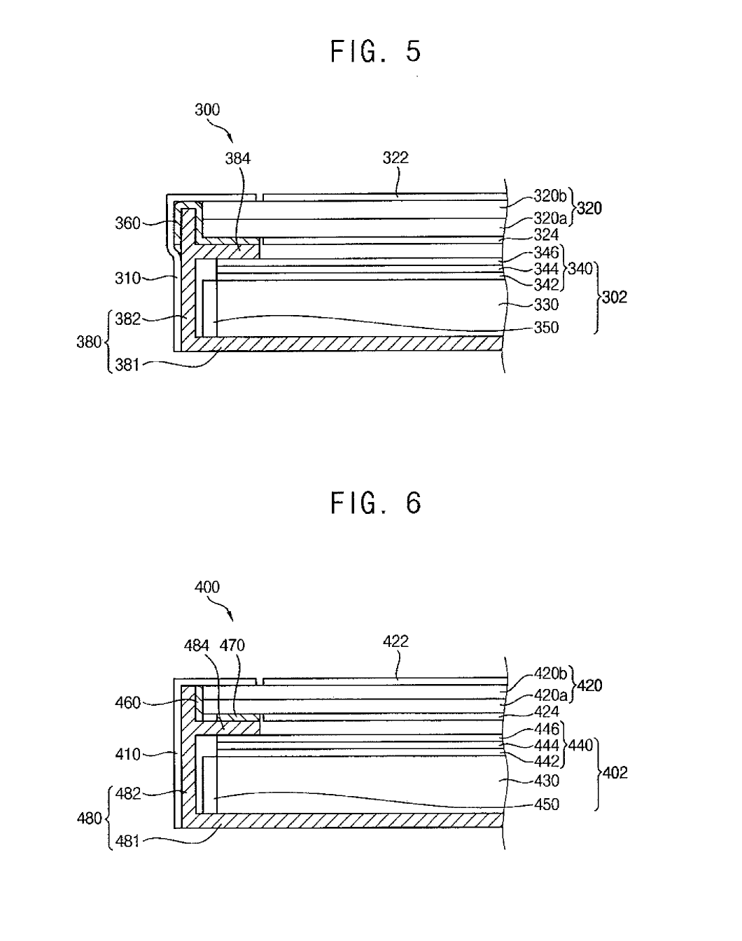

FIG. 5 is a cross-sectional view illustrating a display apparatus according to an exemplary embodiment of the invention.

Referring to FIG. 5, the display apparatus 300 is substantially same as the display apparatus of FIGS. 1 and 2, except for a first panel supporting part 360. Thus, any further detailed descriptions concerning the same elements will be omitted.

The first panel supporting part 360 covers, for example, an upper portion of a first side wall 382 and an upper surface of the first protrusion 384. The first panel supporting part 360 extends along with the first side wall 382. Thus, the first panel supporting part 360 surrounds the upper portion of the first side wall 382, a portion of an outside surface of the first side wall 382, a portion of an inside of the first side wall 382, and the upper surface of the first protrusion 384. Therefore the first panel supporting part 360 makes contact with a first side of the display panel 320 and a lower surface of the display panel 320 adjacent to the first side, so that the display panel 320 which includes array substrate 320a and opposite substrate 320b is supported by the first panel supporting part 360.

In addition, the first panel supporting part 360 may include, for example, elastic insulation material. For example, the first panel supporting part 360 may include rubber, silicon and the like. The first panel supporting part 360 includes elastic insulation material, so that the first panel supporting part 360 may fix the display panel 320 in the receiving container 380 and protect the display panel 320 from an outside impact.

In addition, the first panel supporting part 360 may include, for example, an adhesive layer which contacts to the upper portion of the first side wall 382 and the upper surface of the first protrusion 384. Thus, the first panel supporting part 360 may be attached to the upper portion of the first side wall 382 and the upper surface of the first protrusion 384 by the adhesive layer.

In addition, the upper portion of the first side wall 382 of the receiving container 380 is surrounded by the first panel supporting part 360. Thus, when the display apparatus 300 is manufactured, a worker may be protected from being wounded by sharp edges of the first side wall 382 of the receiving container 380.

Further, as shown in FIG. 5, the display apparatus 300 also includes a backlight assembly 302 including, for example, a light guiding plate 330, an optical element 340, and a light source 350 similar to the backlight assembly 102 of FIGS. 1 and 2. The optical element 340 is disposed on the light guiding plate 330 and may include, for example, a protecting sheet 346, a prism sheet 344 and a diffusion sheet 342 similar to the optical element 140 of the display apparatus 100 of FIGS. 1 and 2. Moreover, the display apparatus 300 also includes, for example, an upper polarizer 322 disposed on the display panel 320 and a lower polarizer 324 disposed under the display panel 320 similar to the upper polarizer 122 and lower polarizer 124 of the display apparatus 100 of FIGS. 1 and 2.

In addition, the display apparatus 300 further includes covering part 310 which may be, for example, an adhesive tape, so that the covering part 110 may fix the display panel 320 in the receiving container 380 by being attached to the peripheral portion of the display panel 320, a portion of the first panel supporting part 360, and a portion of outside of the first side wall 382 similar to the covering part of the display apparatus 100 of FIGS. 1 and 2.

FIG. 6 is a cross-sectional view illustrating a display apparatus according to an exemplary embodiment of the invention.

Referring to FIG. 6, the display apparatus 400 is substantially same as the display apparatus of FIGS. 1 and 2, except for a first panel supporting part 460. Thus, any further detailed descriptions concerning the same elements will be omitted.

The receiving container 480 receives a backlight assembly 402 which includes optical element 440, light source 450, and light guiding plate 430 and a display panel 420 which includes array substrate 420a and opposite substrate 420b. The optical element 440 is disposed on the light guiding plate 430 and may include, for example, a protecting sheet 446, a prism sheet 444 and a diffusion sheet 442 similar to the optical element 140 of the display apparatus 100 of FIGS. 1 and 2.

The receiving container 480 may consist of, for example, metal. For example, the receiving container 480 may consist of at least one of the following materials of aluminum, aluminum alloys, stainless steel, or steel electro galvanized cold-rolled coil (SECC). The receiving container 480 includes, for example, a bottom portion 481 and a first side wall 482. The first side wall 482 extends, for example, from a first side of the bottom portion 481 along a direction substantially perpendicular to the bottom portion 481.

The first panel supporting part 460 covers, for example, an inside upper portion of a first side wall 482. The first panel supporting part 460 extends along with the first side wall 482. Thus, the first panel supporting part 460 surrounds the inside upper portion of the first side wall 482. Therefore the first panel supporting part 460 makes contact with a side of the display panel 420.

In addition, the first panel supporting part 460 may include, for example, elastic insulation material. For example, the first panel supporting part 460 may include rubber, silicon and the like. The first panel supporting part 460 includes, for example, an elastic insulation material, so that the first panel supporting part 460 may fix the display panel 420 in the receiving container 480 and protect the display panel 420 from an outside impact.

In addition, the first panel supporting part 460 may include, for example, an adhesive layer which contacts to the inside upper portion of the first side wall 482. Thus, the first panel supporting part 460 may be attached to the inside upper portion of the first side wall 482 by the adhesive layer.

A covering part 410 covers, for example, a peripheral portion of the display panel 420, the outside of the first side wall 482 of the receiving container 480 and is configured to fix the display panel 420 which includes array substrate 420a and opposite substrate 420b in the receiving container 480. The covering part 410 may be, for example, an adhesive tape, so that the covering part 410 may fix the display panel 420 in the receiving container 480 by being attached to the peripheral portion of the display panel 420 and the outside of the first side wall 482.

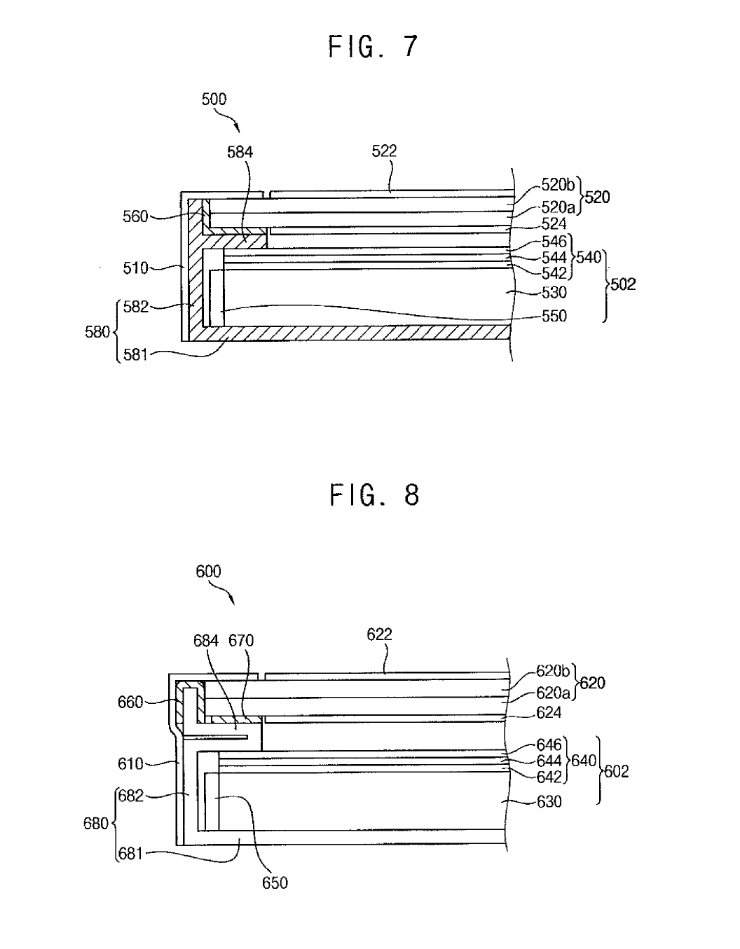

FIG. 7 is a cross-sectional view illustrating a display apparatus according to an exemplary embodiment of the invention.

Referring to FIG. 7, the display apparatus 500 is substantially same as the display apparatus of FIGS. 1 and 2, except for a first panel supporting part 560. Thus, any further detailed descriptions concerning the same elements will be omitted.

The first panel supporting part 560 covers, for example, an inside upper portion of a first side wall 582 and an upper surface of a first protrusion 584. The first panel supporting part 560 extends along with the first side wall 582. Thus, the first panel supporting part 560 surrounds the inside upper portion of the first side wall 582 and the upper surface of the first protrusion 584. Therefore the first panel supporting part 560 makes contact with a first side of the display panel 520 and a lower surface of the display panel 520 adjacent to the first side, so that the display panel 520 is supported by the first panel supporting part 560.

In addition, the first panel supporting part 560 may include, for example, elastic insulation material. For example, the first panel supporting part 560 may include rubber, silicon and the like. The first panel supporting part 560 includes elastic insulation material, so that the first panel supporting part 560 may fix the display panel 520 in the receiving container 580 and protect the display panel 520 from an outside impact.

In addition, the first panel supporting part 560 may include, for example, an adhesive layer which contacts to the upper portion of the first side wall 582 and the upper surface of the first protrusion 584. Thus, the first panel supporting part 560 may be attached to the upper portion of the first side wall 582 and the upper surface of the first protrusion 584 by the adhesive layer.

A covering part 510 covers, for example, a peripheral portion of the display panel 520, the outside of the first side wall 582 of the receiving container 580 and is configured to fix the display panel 520 in the receiving container 580. The covering part 510 may be, for example, an adhesive tape, so that the covering part 510 may fix the display panel 520 which includes array substrate 520a and opposite substrate 520b by being attached to the peripheral portion of the display panel 520 and the outside of the first side wall 582.

Further, as shown in FIG. 7, the display apparatus 500 also includes a backlight assembly 502 including, for example, a light guiding plate 530, an optical element 540, and a light source 550 similar to the backlight assembly 102 of FIGS. 1 and 2. The optical element 540 is disposed on the light guiding plate 530 and may include, for example, a protecting sheet 546, a prism sheet 544 and a diffusion sheet 542 similar to the optical element 140 of the display apparatus 100 of FIGS. 1 and 2. Moreover, the display apparatus 500 also includes, for example, an upper polarizer 522 disposed on the display panel 520 and a lower polarizer 524 disposed under the display panel 520 similar to the upper polarizer 122 and lower polarizer 124 of the display apparatus 100 of FIGS. 1 and 2.

FIG. 8 is a cross-sectional view illustrating a display apparatus according to an exemplary embodiment of the invention.

Referring to FIG. 8, the display apparatus 600 is substantially same as the display apparatus of FIGS. 1 and 2, except for a first protrusion 684 of a first side wall 682 of a receiving container 680. Thus, any further detailed descriptions concerning the same elements will be omitted.

The receiving container 680 receives the backlight assembly 602 which includes optical element 640, light source 650, and light guiding plate 630 and the display panel 620 which includes array substrate 620a and opposite substrate 620b. The optical element 640 is disposed on the light guiding plate 630 and may include, for example, a protecting sheet 646, a prism sheet 644 and a diffusion sheet 642 similar to the optical element 140 of the display apparatus 100 of FIGS. 1 and 2.

The receiving container 680 may consist of, for example, metal. For example, the receiving container 680 may consist of at least one of the following materials of aluminum, aluminum alloys, stainless steel, or steel electro galvanized cold-rolled coil (SECC). The receiving container 680 includes, for example, a bottom portion 681 and a first side wall 682. The first side wall 682 extends from a first side of the bottom portion 681 along a direction substantially perpendicular to the bottom portion 681.

A first protrusion 684 is formed inside of the first side wall 682. The first protrusion 684 is formed from a portion of the first side wall 682 by, for example, hemming bending. Thus, the portion of the first side wall 682 extends, for example, along a direction in parallel with the bottom portion 681, and is bended in U-shape to form the first protrusion 684, and extends along a direction perpendicular to the bottom portion 681 to form a upper portion of the first side wall 682. Thus, the thickness of the first protrusion 684 may be about twice of thickness of the first side wall 682.

A second panel supporting part 670 is disposed on an upper surface of the first protrusion 684, which is parallel with the bottom portion 681. The second panel supporting part 670 is disposed under the first side of the display panel 620 to support the display panel 620. Thus, the second panel supporting part 670 makes contact with the display panel 620 and the first protrusion 684.

In addition, the second panel supporting part 670 may include, for example, elastic insulation material. For example, the second panel supporting part 670 may include rubber, silicon and the like. The second panel supporting part 670 includes, for example, an elastic insulation material, so that the second panel supporting part 670 may fix the display panel 620 in the receiving container 680 and protect the display panel 620 from the outside.

The covering part 610 covers, for example, a peripheral portion of the display panel 620, the outside of the first side wall 682 of the receiving container 680 and is configured to fix the display panel 620 in the receiving container 680. The covering part 610 covers the peripheral portion of the display panel 620, a portion of the first panel supporting part 660, and a portion of outside of the first side wall 682. The covering part 610 may be, for example, an adhesive tape, so that the covering part 610 may fix the display panel 620 by being attached to the peripheral portion of the display panel 620, the portion of the first panel supporting part 660, and the portion of outside of the first side wall 682.

Moreover, the display apparatus 600 also includes, for example, an upper polarizer 622 disposed on the display panel 620 and a lower polarizer 624 disposed under the display panel 620 similar to the upper polarizer 122 and lower polarizer 124 of the display apparatus 100 of FIGS. 1 and 2.

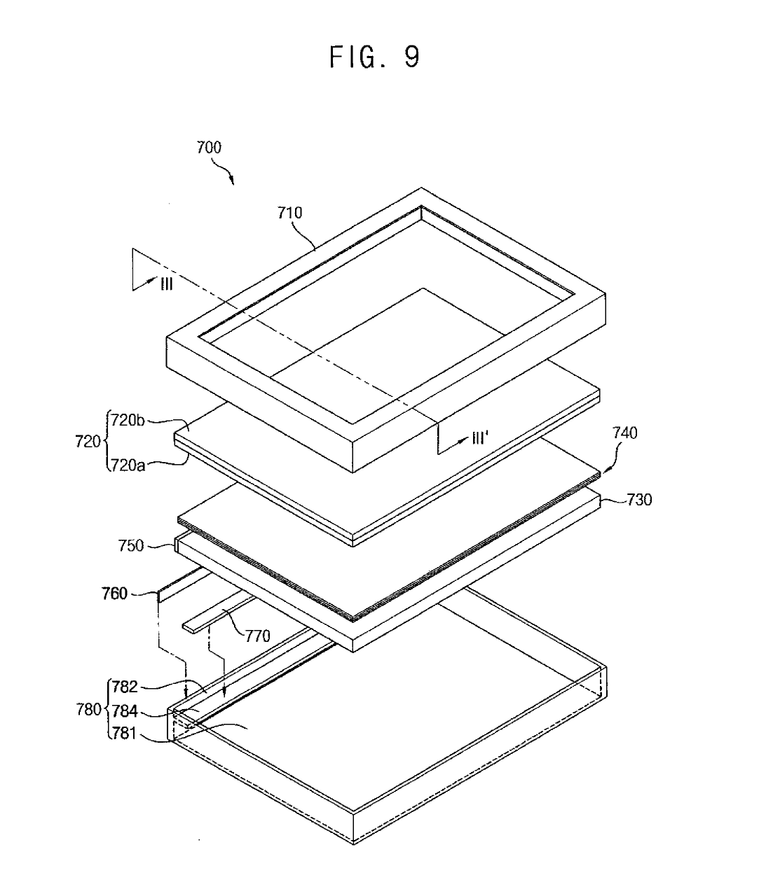

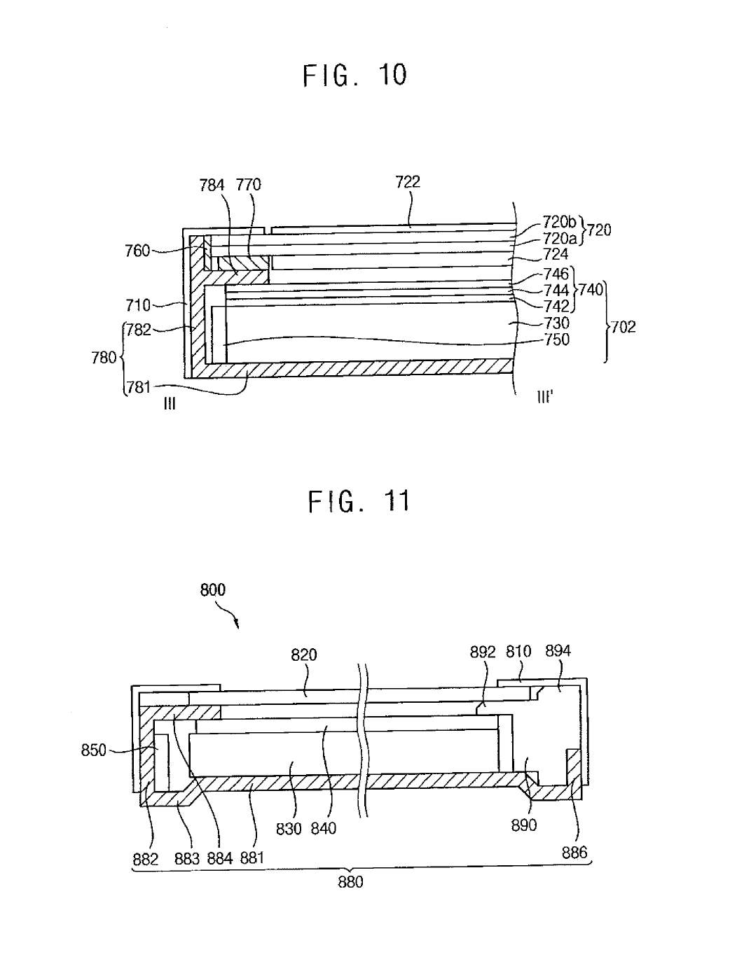

FIG. 9 is an exploded perspective view illustrating a display apparatus according to an exemplary embodiment of the invention. FIG. 10 is a cross-sectional view taken along a line III-III′ of FIG. 9.

Referring to FIGS. 9 and 10, the display apparatus 700 is substantially same as the display apparatus of FIGS. 1 and 2, except for a top chassis 710 and a bottom chassis 780. Thus, any further detailed descriptions concerning the same elements will be omitted

The bottom chassis 780 receives the backlight assembly 702 which includes optical element 740, light source 750, and light guiding plate 730 and the display panel 720 which includes array substrate 720a and opposite substrate 720b. The optical element 740 is disposed on the light guiding plate 730 and may include, for example, a protecting sheet 746, a prism sheet 744 and a diffusion sheet 742 similar to the optical element 140 of the display apparatus 100 of FIGS. 1 and 2.

The bottom chassis 780 may consist of, for example, metal. For example, the bottom chassis 780 may consist of at least one of the following materials of aluminum, aluminum alloys, stainless steel, or steel electro galvanized cold-rolled coil (SECC). The bottom chassis 780 includes, for example, a bottom portion 781 and a first side wall 782. The first side wall 782 extends from a first side of the bottom portion 781 along a direction, for example, substantially perpendicular to the bottom portion 781.

A first panel supporting part 760 extends along the first side wall 782 and surrounds a portion of an inside surface of the first side wall 782. The first panel supporting part 760 also makes contact with a side of the display panel 720.

A first protrusion 784 is formed inside of the first side wall 782. A second panel supporting part 770 is disposed on an upper surface of the first protrusion 784, which is in parallel with the bottom portion 781. The second panel supporting part 770 is disposed under the first side of the display panel 720 to support the display panel 720. Thus, the second panel supporting part 770 makes contact with the display panel 720 and the first protrusion 784.

The top chassis 710 covers, for example, a peripheral portion of a display panel 720, the outside of the first side wall 782 of the bottom chassis 780 and is configured to fix the display panel 720 in the bottom chassis 780. Thus, the top chassis 710 and the bottom chassis 780 are combined together to receive a backlight assembly 702 and the display panel 720. The top chassis 710 may be formed of, for example, a metal having high strength and resistance to deformation. For example, in an exemplary embodiment, the top chassis 710 may be formed of at least one of the following materials of aluminum, aluminum alloys, stainless steel, or steel electro galvanized cold-rolled coil (SECC).

Moreover, the display apparatus 700 also includes, for example, an upper polarizer 722 disposed on the display panel 720 and a lower polarizer 724 disposed under the display panel 720 similar to the upper polarizer 122 and lower polarizer 124 of the display apparatus 100 of FIGS. 1 and 2.

FIG. 11 is a cross-sectional view illustrating a display apparatus according to an exemplary embodiment of the invention.

Referring to FIG. 11, the display apparatus 800 is substantially same as the display apparatus of FIGS. 1 and 2, except for a receiving container 880, a light source 850 and a supporting part 890. Thus, any further detailed descriptions concerning the same elements will be omitted.

The receiving container 880 includes, for example, a receiving portion 883 disposed adjacent to a first side wall 882 to form a light source receiving space. The receiving portion 883 may be formed by, for example, being recessed from a bottom portion 881. The light source 850 is received in the light source receiving space. The light source 850 may be attached on the first side wall 882. Although the light source 850 is spaced apart from a light guiding plate 830, the light source receiving space is a portion of the receiving container 880 which includes metal, so that light generated from the light source 850 may be reflected on a surface of the light source receiving space to guide the light toward the light guiding plate 830. For example, in an exemplary embodiment, the receiving container 880 may consist of at least one of the following materials of aluminum, aluminum alloys, stainless steel, or steel electro galvanized cold-rolled coil (SECC).

An upper portion of the first side wall 882 may be, for example, bent to form a first protrusion 884. The first protrusion 884 supports a display panel 820. In addition, the first protrusion 884 may contact with an optical element 840 to fix the optical element 840 and the light guiding plate 830 in the receiving container 880.

The supporting part 890 is disposed adjacent to a second side wall 886, and may contact with the second side wall 886. The supporting part 890 includes, for example, a first supporting part 892 and a second supporting part 894. The first supporting part 892 is, for example, protruded from the supporting part 890, and is disposed between the display panel 820 and the optical element 840. The first supporting part 892 is configured to support the display panel 820 thereon. The second supporting part 894 is disposed between a side of the display panel 820 and a covering part 810 and is configured to protect the side of the display panel 820.

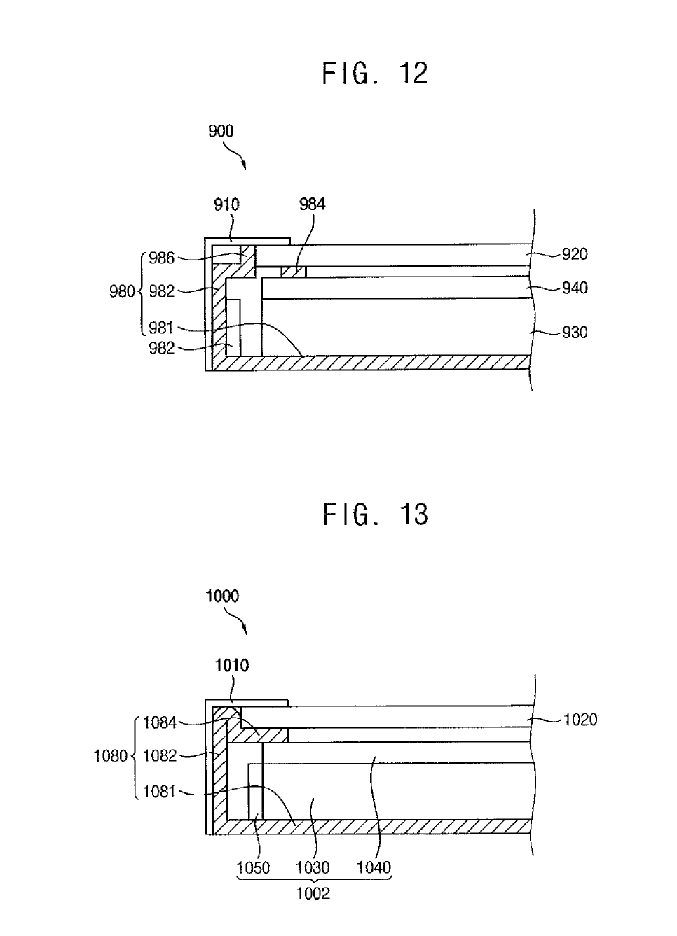

FIG. 12 is a cross-sectional view illustrating a display apparatus according to an exemplary embodiment of the invention.

Referring to FIG. 12, the display apparatus 900 is substantially same as the display apparatus of FIG. 11, except for a receiving container 980. Thus, any further detailed descriptions concerning the same elements will be omitted

The receiving container 980 includes, for example, a bottom portion 981 and a first side wall 982. The first side wall 982 extends, for example, from a first side of the bottom portion 981 along a direction substantially perpendicular to the bottom portion 981.

The receiving container 980 further includes, for example, a first protrusion 984 and a hook 986. The first protrusion 984 extends, for example, from the first side wall 982 in parallel with the bottom portion 981. A portion of the first protrusion 984 may be, for example, bent to form the hook 986. The hook 986 and the first protrusion 984 support a side of a display panel 920 and boundaries of the display panel 920, respectively. The hook 986 may be formed by, for example, punching the portion of the first protrusion 984 and bending the portion.

Further, as shown in FIG. 12, the display apparatus 900 may further include a light guiding plate 930 and an optical element 940 disposed thereon which are each received in receiving container 980. In addition, the display apparatus 900 may further include covering part 910 which may be, for example, an adhesive tape, and which may fix the display panel 920 in the receiving container 980 by being attached to the peripheral portion of the display panel 920.

FIG. 13 is a cross-sectional view illustrating a display apparatus according to an exemplary embodiment of the invention.

Referring to FIG. 13, the display apparatus 1000 is substantially same as the display apparatus of FIGS. 1 and 2, except for a receiving container 1080. Thus, any further detailed descriptions concerning the same elements will be omitted.

The receiving container 1080 includes, for example, a bottom portion 1081, a first side wall 1082 and a first protrusion 1084. The first side wall 1082 extends, for example, from a first side of the bottom portion 1081 along a direction substantially perpendicular to the bottom portion 1081. The first protrusion 1084 may be formed by, for example, hemming bending of an upper portion of the first side wall 1082.

Further, as shown in FIG. 13, the display apparatus 1000 may also include a light guiding plate 1030 and an optical element 1040 disposed thereon with each received in receiving container 1080. In addition, the display apparatus 1000 may further include covering part 1010 which may be, for example, an adhesive tape, and which may fix the display panel 1020 in the receiving container 1080 by being attached to the peripheral portion of the display panel 1020.

FIGS. 14A and 14B are perspective views to explain a method for manufacturing a receiving container of the display apparatus of FIG. 1.

Referring to FIGS. 14A, 1 and 2, a bottom portion 181, a first side wall 182 and a first protrusion 184 of a receiving container 180 may be formed along an arrow in the figure by, for example, an extruding process. The receiving container 180 includes, for example, metal, so that the receiving container 180 may be formed by a traditional extruding process which is well known in metal-working processes.

For example, referring to FIGS. 14B, 1 and 2, after the extruding process, both ends of the first side wall 182 and the first protrusion 184 may be cut. Both ends of the bottom portion which are not connected to the first side wall 182 (refers to dotted line in figure) may be, for example, bent to form the receiving container 180.

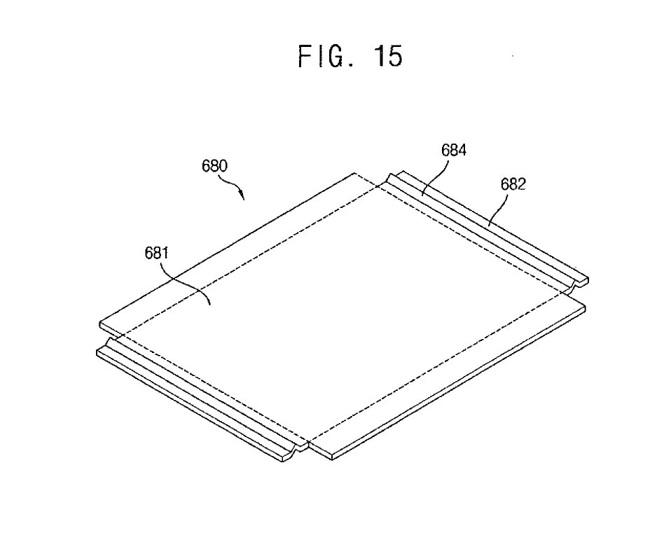

FIG. 15 is a perspective views to explain a method for manufacturing a receiving container of the display apparatus of FIG. 8.

Referring to FIGS. 15 and 8, a bottom portion 681 and a first side wall 682 of the receiving container 680 are formed. For example, the bottom portion 681 and the first side wall 682 are formed in a planar shape by a traditional press process, thereafter a portion of the first side wall 682 for a first protrusion 684 is firstly bent, and thereafter the first side wall 682 is secondly bent to form a V-shaped cross section of the first protrusion 684. Thereafter, the first protrusion 684 is completely formed by, for example, hemming-bending. After that, the first side wall 682 is, for example, bent (refers to dotted line in figure) to form the receiving container 680.

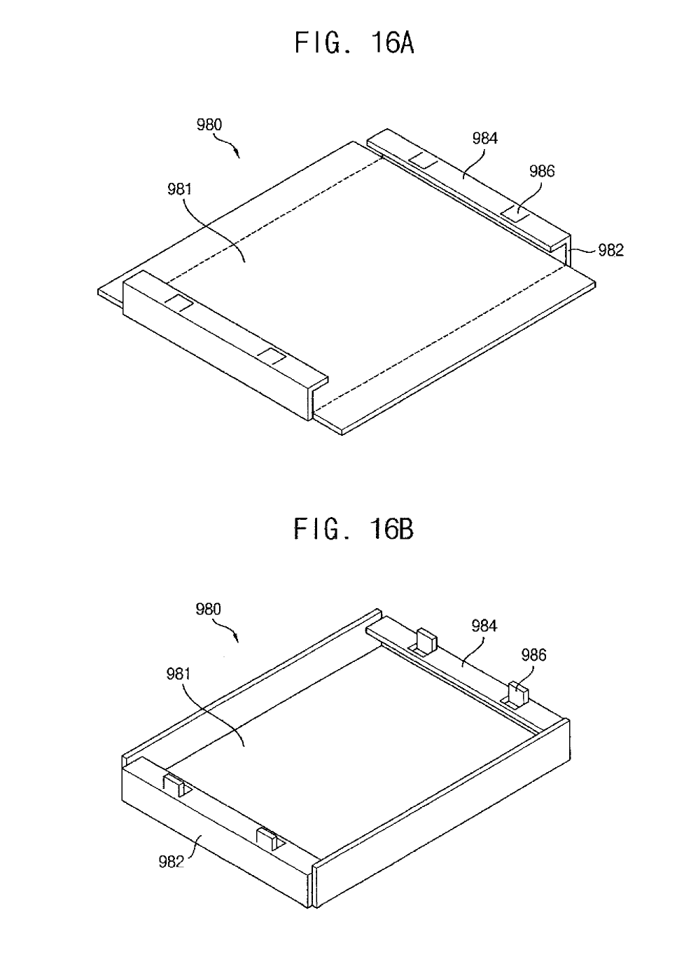

FIGS. 16A and 16B are perspective views to explain a method for manufacturing a receiving container of the display apparatus of FIG. 12.

Referring to FIGS. 16A, 16B and 12, a bottom portion 981, a first side wall 982 and a first protrusion 984 of the receiving container 980 are formed. A hook 986 is formed from a portion of the first protrusion 984 by, for example, a punching process and bending process. For example, the bottom portion 981, the first side wall 982 and the first protrusion 984 may be formed by a traditional press process and a bending process. In addition, the hook 986 may be formed by, for example, a punching process and a bending process. Thereafter a side wall is, for example, bent (refers to dotted line in figure) to form the receiving container 980.

According to exemplary embodiments of the present invention, a display panel includes, for example, a first side wall of a receiving container having a first protrusion, so that a display panel and a backlight assembly may be received without a traditional mold frame.

In addition, a first panel supporting part including, for example, elastic insulation material is disposed between the first side wall and a first side of the display panel. A second panel supporting part including, for example, an elastic insulation material is disposed on the first protrusion. Thus, the display panel may be fixed in the receiving container, and the display panel may be protected from an outside impact.

In addition, an upper portion of the first side wall of the receiving container is surrounded by the first panel supporting part. Thus, when the display apparatus is manufactured, a worker may be protected from being wounded by sharp edges of the first side wall of the receiving container.

In addition, the receiving container may consist of, for example, metal and has elastic restoring force, and the first protrusion has relatively small size compared to the whole receiving container, so that the backlight assembly may be inserted into the space below the first protrusion by the elastic restoring force of the receiving container.

In addition, the receiving container includes, for example, metal having relatively high reflectivity, so that the receiving container may reflect light from a light source toward the first side wall and the first protrusion without an additional reflecting plate. In addition, heat generated from the light source may be effectively dissipated. In addition, the receiving container may reflect light, which is from a lower surface of the light guiding plate, to a light guiding plate without an additional reflecting element under the light guiding plate.

In addition, the receiving container includes a receiving space for the light source, and the receiving container may guide light adjacent to the light source to the light guiding plate.

Having described the exemplary embodiments of the present invention, it is further noted that it is readily apparent to those of ordinary skill in the art that various modifications may be made without departing from the spirit and scope of the invention which is defined by the metes and bounds of the appended claims.

What is claimed is:

1. A display apparatus comprising:
a display panel;
a light source part disposed under the display panel and configured to supply light to the display panel; and
a receiving container configured to receive the display panel and the light source part,
wherein the receiving container comprises:
a bottom portion and a first side wall extending from a first side of the bottom portion along a direction substantially perpendicular to the bottom portion, and
a first protrusion disposed inside of the first side wall, wherein the first protrusion is disposed between a lower surface of the display panel adjacent to the first side of the display panel and an upper surface of the light source part,
and wherein the receiving container comprises a metal.

2. The display apparatus of claim 1, wherein the first protrusion is substantially parallel with the bottom portion, and
wherein the first protrusion makes contact with the lower surface of the display panel adjacent to the first side of the display panel and configured to support the display panel thereon.

3. The display apparatus of claim 2, wherein the first protrusion extends from an upper portion of the first side wall.

4. The display apparatus of claim 3, wherein a hook is disposed on the first protrusion, and wherein the hook makes contact with the first side of the display panel.

5. The display apparatus of claim 1, further comprising a first panel supporting part disposed on an inside upper portion of the first side wall, wherein the first panel supporting part comprising an elastic insulation material.

6. The display apparatus of claim 5, wherein the first panel supporting part has a U-shaped cross section, and surrounds the inside upper portion, an outside upper portion and an upper surface of the first side wall.

7. The display apparatus of claim 6, wherein the first panel supporting part is a shrink tube.

8. The display apparatus of claim 6, further comprising a second panel supporting part comprising an elastic insulation material and disposed on the first protrusion of the first side wall,
wherein the second panel supporting part makes contact with the lower surface of the display panel adjacent to the first side of the display panel.

9. The display apparatus of claim 8, further comprising a second side wall extending from a second side of the bottom portion along a direction substantially perpendicular to the bottom portion, wherein the second side being opposite to the first side, wherein the second side wall facing the first side wall,
and wherein a second protrusion is formed inside of the second side wall.

10. The display apparatus of claim 9, further comprising:
a third panel supporting part disposed on an inside upper portion of the second side wall, wherein the third panel supporting part comprising an elastic insulation material; and
a fourth panel supporting part disposed on the second protrusion of the second side wall, wherein the fourth panel supporting part comprising an elastic insulation material.

11. The display apparatus of claim 5, further comprising a covering part surrounding a peripheral portion of the display panel and an outside of the first side wall of the receiving container.

12. The display apparatus of claim 11, further comprising a polarizer disposed on the display panel, and exposing the peripheral portion of the display panel,
wherein a thickness of the polarizer is the same as a thickness of the covering part

13. The display apparatus of claim 11, wherein the covering part is a tape comprising an adhesive layer, and wherein the adhesive layer is attached to the peripheral portion of the display panel and the outside of the first side wall of the receiving container.

14. The display apparatus of claim 11, wherein the covering part is a top chassis combined with the receiving container configured to receive the display panel and the light source part.

15. The display apparatus of claim 5, wherein the first panel supporting part extends to the first protrusion, and covers the inside upper portion of the first side wall and an upper surface of the first protrusion.

16. The display apparatus of claim 1, wherein the light source part comprises a light guiding plate, and a light source disposed on a first side surface of the light guiding plate,
wherein the light source is received in a space formed by the first side wall, the first protrusion and the bottom portion of the receiving container.

17. The display apparatus of claim 16, wherein the light source part further comprises an optical element disposed on the light guiding plate.

18. The display apparatus of claim 17, wherein the optical element comprises a diffusion sheet, a prism sheet, and a protecting sheet,
wherein the protecting sheet is disposed at a top of the optical element, and
wherein an upper surface of the protecting sheet adjacent to a first side of the protecting sheet makes contact with a lower surface of the first protrusion of the first side wall of the receiving container.

19. The display apparatus of claim 16, wherein the light source is spaced apart from the first side wall of the receiving container.

20. The display apparatus of claim 16, wherein the receiving container comprises a metal having elastic restoring force, and
wherein the light source makes contact with the first side wall of the receiving container.

21. The display apparatus of claim 17, wherein the receiving container comprises a metal having relatively high reflectivity, and
wherein the light guiding plate makes contact with the bottom portion of the receiving container.

22. The display apparatus of claim 20, wherein the light source part further comprises an optical element disposed on the light guiding plate.

23. The display apparatus of claim 1, wherein,
wherein a thickness of the first protrusion is about twice of a thickness of the first side wall.

24. A display apparatus comprising:
a display panel;
a light source part disposed under the display panel and configured to supply light to the display panel; and
a receiving container configured to receive the display panel and the light source part,
wherein the receiving container comprises:
a bottom portion and a first side wall extending from a first side of the bottom portion along a direction substantially perpendicular to the bottom portion, and
a first protrusion disposed inside of the first side wall, wherein the first protrusion is disposed between a lower surface of the display panel adjacent to the first side of the display panel and an upper surface of the light source part, and
wherein a thickness of first side wall is substantially the same as a thickness of the first protrusion.

25. The display apparatus of claim 24, wherein a thickness of the bottom portion is the same as the thickness of first side wall.

26. A method for manufacturing a receiving container for a display apparatus, comprising:
forming a bottom portion and a first side wall of a receiving container, wherein the first side wall extends from a first side of the bottom portion along a direction substantially perpendicular to the bottom portion;
forming a first protrusion disposed inside of the first side wall, wherein the first protrusion is configured to be disposed between a lower surface of a display panel of the display apparatus adjacent to a first side of the display panel and an upper surface of a light source part of a backlight unit disposed under the display panel, and wherein the receiving container comprises a metal; and
bending ends of the bottom portion which are not connected to the first sidewall to form the receiving container.

27. The method of claim 26, wherein the bottom portion and the first sidewall are formed by an extruding process.

28. The method of claim 26, further comprising:
performing a punching process on a portion of the first protrusion; and
performing a bending process on the portion the first protrusion to thereby form a hook portion extending from the first protrusion.

29. The method of claim 28, wherein prior to the bending of the ends of the bottom portion which are not connected to the first sidewall, the method further comprising cutting both ends of the first sidewall and the first protrusion.

30. The method of claim 26, wherein the bottom portion and the first sidewall are formed in a planar shape by a press process, and
wherein the forming of the first protrusion comprises:
firstly bending a portion of the first sidewall, secondly bending the first sidewall to provide a portion of the first sidewall having a v-shaped cross section; and
forming the first protrusion by performing a hemming-bending process on the first sidewall having the v-shaped cross-section.

31. The method of claim 26, wherein the bottom portion, the first sidewall and the first protrusion are formed by a press process and a bending process.

32. The method of claim 31, further comprising forming a hook portion extending from the first protrusion by a punching process and a bending process.

33. The method of claim 26, wherein the first protrusion of the first side wall of the receiving container is formed from a portion of the first sidewall by a hemming-bending process.
